(19) United States
(12) Patent Application Publication
(10) Pub. No.: US 2005/0282028 A1
(43) Pub. Date: Dec. 22, 2005

(54) Blends composed of styrene-butadiene block copolymers and of polyolefins for transparent, elastic films

(75) Inventor: Robert Huber, Limburgerhof (DE)

Correspondence Address: CONNOLLY BOVE LODGE & HUTZ LLP, SUITE 800, 1990 M STREET NW, WASHINGTON, DC, 20036-3425, US

(73) Assignee: BASF AKTIENGESELLSCHAFT, Ludwigshafen (DE)

(21) Appl. No.: 11/148,414

(22) Filed: Jun. 9, 2005

(30) Foreign Application Priority Data
Jun. 17, 2004 (DE) 102004029138.1

(51) Int. Cl. B32B 7/12

(52) U.S. Cl. 428/522

(57) ABSTRACT

A stretch film, comprising A) from 40 to 95% by weight of a thermoplastic elastomer based on styrene (S-TPE) B) from 5 to 60% by weight of a polyolefin, and its use for the packaging of product units.

The invention relates to a stretch film, comprising
A) from 40 to 95% by weight of a thermoplastic elastomer based on styrene (S-TPE)
B) from 5 to 60% by weight of a polyolefin,
   and its use for the packaging of product units.

The films generally used for the packaging of product units, using stretch hood machines or stretch winding machines, are single- or multilayer elastic films composed of polyolefins, for example those described in EP-A 1 201 406.

The tubular films used hitherto for stretch hood packaging often have insufficient resilience. Given a certain size of the tubular films, there is therefore a restriction to narrow limits for the size of the product units to be packaged.

Styrene-butadiene-styrene block copolymers exhibit very good resilience, but the butadiene block can cause crosslinking and fish-eye formation. U.S. Pat. No. 5,972,519 and WO 96/23823 describe flexible, transparent films composed of styrene-butadiene block copolymers having a random styrene-butadiene copolymer block, for food packaging.

It is an object of the present invention to eliminate the disadvantages described and to provide films which have high resilience and are free from fish-eyes and which, even when film thicknesses are low, have adequate puncture resistance and in particular are suitable as stretch films for the packaging of product units.

Accordingly, the stretch film described at the outset has been found. The stretch film preferably comprises
A) from 60 to 80% by weight of a thermoplastic elastomer based on styrene (S-TPE)
B) from 20 to 40% by weight of a polyolefin.
   Component A

The S-TPE preferably has tensile strain at break of more than 300%, particularly preferably more than 500%, in particular more than 600%, measured to ISO 527, and the amount of this material admixed is from 40 to 95% by weight, preferably from 60 to 80% by weight, based on the stretch film. The S-TPE more preferably used for admixing comprises a linear or star-shaped styrene-butadiene block copolymer with external polystyrene blocks S and, between these, styrene-butadiene copolymer blocks with random styrene/butadiene distribution (S/B)_{random}, or with a styrene gradient (S/B)ₜₐₚₑᵣ.

The total butadiene content is preferably in the range from 15 to 50% by weight, particularly preferably in the range from 25 to 40% by weight, and the total styrene content is accordingly preferably in the range from 50 to 85% by weight, particularly preferably in the range from 60 to 75% by weight.

The styrene-butadiene block (S/B) is preferably composed of from 30 to 75% by weight of styrene and from 25 to 70% by weight of butadiene. A block (S/B) particularly preferably has a butadiene content of from 35 to 70% by weight and a styrene content of from 30 to 65% by weight.

The proportion of the polystyrene blocks S is preferably in the range from 5 to 40% by weight, in particular in the range from 25 to 35% by weight, based on the entire block copolymer. The proportion of the copolymer blocks S/B is preferably in the range from 60 to 95% by weight, in particular in the range from 65 to 75% by weight.

Particular preference is given to linear styrene-butadiene block copolymers of the general structure S-(S/B)-S having, situated between the two S blocks, one or more (S/B)_{random} blocks having random styrene/butadiene distribution. These block copolymers are obtainable via anionic polymerization in a non-polar solvent with addition of a polar cosolvent or of a potassium salt, as described by way of example in WO 95/35335 or WO 97/40079.

Vinyl content is the relative proportion of 1,2-linkages of the diene units, based on the entirety of 1,2-, 1,4-cis and 1,4-trans linkages. The 1,2-vinyl content in the styrene-butadiene copolymer block (S/B) is preferably below 20%, in particular in the range from 10 to 18%, particularly preferably in the range from 12 to 16%.

Component B

Examples of suitable component B are semicrystalline polyolefins, such as homo- or copolymers of ethylene, propylene, 1-butene, 1-pentene, 1-hexene, 4-methyl-1-pentene, and also ethylene copolymers with vinyl acetate, vinyl alcohol, ethyl acrylate, butyl acrylate, or methacrylate. Component B is preferably a high-density polyethylene (HDPE), low-density polyethylene (LDPE), linear low-density polyethylene (LLDPE), polypropylene (PP), ethylene-vinyl acetate copolymer (EVA), or ethylene-acrylic copolymer.

The inventive stretch film may also comprise the usual auxiliaries and additives, such as lubricants, antiblocking agents, release agents, stabilizers, antistatic agents, flame retardants, colorants, etc.

The inventive stretch film may also have a multilayer structure, where at least one layer is composed of components A and B. The other layers may be composed of the polyolefins stated under component B or of mixtures thereof.

The total film thickness of the inventive stretch film is generally in the range from 1 to 250 μm, and the thickness of the stretch film is preferably in the range from 50 to 150 μm.

The inventive stretch film may be produced by suitable processes, such as mono- and coextrusion to give tubular films, chill-roll films, or other extruded films, or by calendering, injection molding, or blow molding.

Stretch packaging is advantageous when film is to be used for waterproof wrapping of products of irregular shape—such as goods on pallets or foods. One system giving relatively quick and versatile results is conventional shrink or winding technology. The high resilience and puncture resistance of the inventive stretch film makes it particularly suitable for the packaging of product units, where the stretch film is drawn over the product units. Suitable processes and apparatus for this are described by way of example in WO 03/062062 or EP-A 1 059 233.

The high extensibility and resilience of the inventive stretch films make them markedly superior to conventional polyethylene films. The higher the proportion of component A, the higher the resilience. If the proportion of component A is high, the resultant reduction in tube diameter can be above 50%, thus making the packaging lighter, while these stretch films nevertheless provide very close contact with the material to be packaged. Given 500% initial strain, stretch films with a proportion above 70% by weight of component A can recover by more than 300%, whereas the recovery achieved with optimized polyethylene films is only about 100%.

Another advantage is that the resilience of the inventive stretch film allows it to cover various sizes of packed material, using one size of tubular film. The result is not only reduced cycle times for packers, because changeover of tubular film is eliminated, but also a reduction in their inventory costs, because only one size of tubular film now needs to be kept in inventory. The lower weight also reduces disposal costs.

### EXAMPLES

Starting Materials:

LDPE: LD 150, low-density polyethylene from Exxon Mobil (density 0.923 g/cm³, MFR (190° C./2.16 kg) 0.75 g/10 min)
EVA Lucalen V 3510 K, ethylene-vinyl acetate copolymer having 18% of vinyl acetate from Basell (density 0.94 g/cm³, MFR (190° C./2.16 kg) 0.7 g/10 min)
EBA FA 4083, ethylene-butyl acrylate copolymer from Borealis (density 0.924 g/cm³, MFR (190° C./2.16 kg) 0.5 g/10 min, butyl acrylate content 8%)
SB Styroflex® 2G66 (thermoplastic elastomer based on a styrene-butadiene block copolymer having a random S/B middle block from BASF Aktiengesellschaft)
   Test Methods:

The test specimens for the mechanical tests were cut out longitudinally and transversely from the films. Modulus of elasticity, tensile stress at break, and tensile strain at break were determined in the ISO 527-2 tensile test.

The puncture resistance test was carried out in accordance with the proposed standard FNK 403.3.

Method for determining recovery after 500% initial extension (hysteresis)
1. Pretension specimen at 0.1 N
2. Tension using test velocity 500 mm/min as far as 100% strain level; keep strain constant for 20 s
3. Reduce load at 500 mm/min to pretension; strain point epsilon-a (record start of recovery time)
4. Reduce load to 0% strain; wait 180 s (recovery time)
5. Increase load as far as pretension and record strain point epsilon-b (end of recovery time)
6. Calculate difference a-b
7. Use the same test specimen for 250 and 500% strain levels (repeating items 2-6 of the sequence)
   Test Method for Determining Resilience (Hysteresis):
1. Pretension specimen at 0.1 N
2. Tension using test velocity 500 mm/min as far as 100, 250, and 500% strain levels
3. Wait 20 s at constant strain; record force at start (FA) and end (FB) of waiting time
4. Reduce load at 500 mm/min to strain levels 50, 125, and 250%
5. Wait 3 min at constant strain; record force at start (Fc) and end (Fd) of waiting time
6. Reduce tension to pretension
7. Plot force against strain
8. Test using strain levels 100, 250, and 500%
9. Measure specimen thickness prior to and after testing
   Production of Films:

The single-layer films were produced via blown-film extrusion. Composition and properties of inventive films F1, F2 and F3 and comparative film (CF) are given in table 1.

TABLE 1

| | | | Resilience after | Tear | |
|---|---|---|---|---|---|
| | | | 250% strain | propagation | |
| | | Recovery | and 125% | resistance, | Puncture |
| Exam- | Composition | after 500% | recovery | DIN 53363 | resistance |
| ple | [% by weight] | strain [%] | [N] (l/t) | [N/mm] (l/t) | [N/mm] |
| CF | SB100 | 390 | 2.1/1.8 | 103/87 | 120 |
| F1 | LDPE/SB 30/70 | 270 | 1.5/1.8 | 153/113 | 90 |
| F2 | EVA/SB 30/70 | 330 | 1.8/2.0 | 131/103 | 122 |
| F3 | EBA/SB 30/70 | 300 | 1.6/1.9 | 135/102 | 93 |

1. A stretch film comprising
A) from 40 to 95% by weight of a thermoplastic elastomer based on styrene (S-TPE) and
B) from 5 to 60% by weight of a polyolefin.

2. The stretch film according to claim 1, which comprises
A) from 60 to 80% by weight of a thermoplastic elastomer based on styrene (S-TPE) and
B) from 20 to 40% by weight of a polyolefin.

3. The stretch film according to claim 1, wherein component A) is a styrene-butadiene block copolymer of S-(S/B)-S structure, where S is a polystyrene block and S/B is a styrene-butadiene copolymer block.

4. The stretch film according to claim 1, wherein component A) is composed of from 15 to 50% by weight of butadiene and from 50 to 85% by weight of styrene.

5. The stretch film according to claim 3, wherein the styrene-butadiene copolymer block S/B of component A) has random distribution of the styrene units and butadiene units.

6. The stretch film according to claim 3, wherein the styrene-butadiene copolymer block (S/B) of component A) is composed of from 30 to 70% by weight of styrene and from 25 to 70% by weight of butadiene.

7. The stretch film according to claim 3, wherein the proportion of the polystyrene blocks S is in the range from 5 to 40% by weight.

8. The stretch film according to claim 3, wherein the 1,2-vinyl content in the styrene-butadiene copolymer block (S/B) of component A) is below 20%.

9. The stretch film according to claim 1, which comprises a polyolefin selected from the group consisting of, a high-density polyethylene (HDPE), low-density polyethylene (LDPE), linear low-density polyethylene (LLDPE), polypropylene (PP), ethylene-vinyl acetate copolymer (EVA), and ethylene-acrylic copolymer.

10. The stretch film according to claim 1, whose thickness is in the range from 1 to 250 μm.

11. A multilayer film comprising at least one layer composed of a stretch film according to claim 1.

12. A process for the packaging of product units, which comprises drawing a stretch film according to claim 1 over the product units.

13. The stretch film according to claim 2, wherein component A) is a styrene-butadiene block copolymer of S-(S/B)-S structure, where S is a polystyrene block and S/B is a styrene-butadiene copolymer block.

14. The stretch film according to claim 2, wherein component A) is composed of from 15 to 50% by weight of butadiene and from 50 to 85% by weight of styrene.

15. The stretch film according to claim 3, wherein component A) is composed of from 15 to 50% by weight of butadiene and from 50 to 85% by weight of styrene.

16. The stretch film according to claim 4, wherein the styrene-butadiene copolymer block S/B of component A) has random distribution of the styrene units and butadiene units.

17. The stretch film according to claim 4, wherein the styrene-butadiene copolymer block (S/B) of component A) is composed of from 30 to 70% by weight of styrene and from 25 to 70% by weight of butadiene.

18. The stretch film according to claim 5, wherein the styrene-butadiene copolymer block (S/B) of component A) is composed of from 30 to 70% by weight of styrene and from 25 to 70% by weight of butadiene.

19. The stretch film according to claim 4, wherein the proportion of the polystyrene blocks S is in the range from 5 to 40% by weight.

20. The stretch film according to claim 5, wherein the proportion of the polystyrene blocks S is in the range from 5 to 40% by weight.
